(19) United States
(12) Patent Application Publication
(10) Pub. No.: US 2008/0059539 A1
(43) Pub. Date: Mar. 6, 2008

(54) Document Collaboration System and Method

(76) Inventors: Richard Chin, San Clemente, CA (US); Jason Lee, San Francisco, CA (US)

Correspondence Address: MINTZ, LEVIN, COHN, FERRIS, GLOVSKY AND POPEO, P.C, 5355 Mira Sorrento Place, Suite 600, SAN DIEGO, CA, 92121, US

(21) Appl. No.: 11/836,087

(22) Filed: Aug. 8, 2007

Related U.S. Application Data
(60) Provisional application No. 60/836,543, filed on Aug. 8, 2006.

(51) Int. Cl. G06F 17/30

(52) U.S. Cl. 707/203; 707/E17.008

(57) ABSTRACT

A system that allows users to create, edit, manage, collaborate and communicate on documents such as word processor documents, spreadsheets, databases, slides, and diagram editors is disclosed. Each document type is broken down into basic workable elements. Each change to a document is tracked in a centralized database under control of a database management system, and users use a web browser and/or desktop as the client front end. Changes to the document are communicated back and forth to the database via a rich asynchronous javascript and XML web page. Changes from multiple sources or sessions can be compared with each other in a side-by-side display environment.

### RELATED APPLICATIONS

This application claims the benefit of U.S. provisional patent application Ser. No. 60/836,543, filed on Aug. 8, 2006 and entitled “Document Collaboration System and Method,” which is incorporated by reference herein in its entirety.

### BACKGROUND

This document relates to electronic document systems, and more particularly to systems and methods for secure online and/or offline document creation, collaboration, version control, management, and communication.

Many people use word processing software such as Microsoft Word to generate an original document on their computer and save it to some destination file or folder. Creating and storing documents in this environment is a fairly efficient process, until changes need to be made to a document, or until the document needs to be shared. Recently new technologies and/or philosophies of developing software have been introduced, such as Wikis and Web 2.0 tools, in which documents can be generated on a centralized web-based system. These technologies provide consistency to how a document looks and where it is stored. They also allow for inclusion of security features and easy sharing with others.

However, in order to make a change to a document using present technologies, the document needs to be opened from its stored location and displayed on a computer screen. Changes include such edits as insertion, deletion, or replacement functions. As shown in FIG. 1 the conventional technologies used for centralized document creation and collaboration are difficult to use, as they can make a document look messy and difficult to understand particularly during editing and versioning.

To share a document file using conventional technologies, an author can attach the file or embed the file within an email to distribute to others. The document can also be stored in a portable medium, and physically distribute among different recipients. In the latter case, the recipients open the document, view, edit, and store on their portable device, file or network system. They can also forward the document in another portable device, or reattach or embed the changed document within an email and send back to the originator or others. As this process can be repeated many times, many different versions of the document may proliferate, causing confusion, overlap and inefficiency.

After several rounds of editing, an original document can look messy, as changes are difficult to use or understand. Many times, whether using an email system or regular mail, comments associated with the document may be provided outside of the document in the body of an email or regular mail. These extra-document comments are very difficult to track, and unless immediately and carefully integrated into the document, these comments may be misplaced or lost.

Conventional document collaboration technologies can be very challenging in terms of tracking changes to an original document, tracking which users did what, which users have what versions, and tracking the comments within the emails or regular mail. Furthermore, these technologies are typically neither secure nor compliant with document integrity standards that are often required in organizations.

### SUMMARY

This document discloses document collaboration systems and methods that allow users to create, edit, manage, and collaborate on documents, and communications among users relating to the documents.

In one aspect, a computer-implemented method includes parsing a document into a set of basic workable elements, each basic workable element being a subset of the document, and communicating selected basic workable elements to designated editing users. The method further includes receiving changes to at least one basic workable element from at least one editing user, and resolving the changes to produce a final version of the at least one basic workable element.

In another aspect, a document collaboration method includes steps of providing a document in a central storage, parsing the document into a set of basic workable elements, each basic workable element being a subset of the document, receiving changes to at least one basic workable element from at least one editing user, and resolving the changes to produce a final version of the at least one basic workable element.

In yet another aspect, a document collaboration system includes a database configured for storing a document, and a workflow engine that executes real-time creation of routing pathways and live designation of specific actions on the document. The system further includes a collaboration module that executes the generation and transmission of invitations to one or more users to provide the specific actions on the document via a network, and a versioning engine that maintains a version history that can be stored in the database and retrieved for review, comparison and editing.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates results of collaboration on a document in a conventional system.

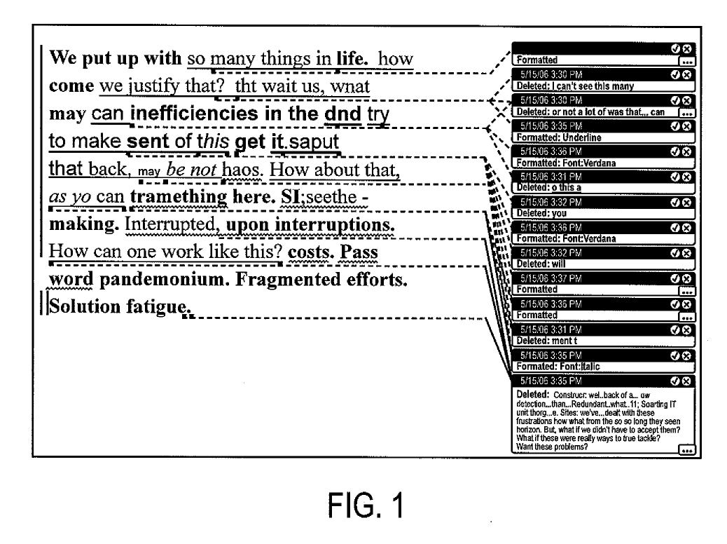

FIG. 2 is a block diagram of a document collaboration system.

FIG. 3 illustrates a collaboration session for a document using the document collaboration system.

FIG. 4 is a flowchart of a workflow for a document collaboration system in accordance with some embodiments.

Like reference symbols in the various drawings indicate like elements.

### DETAILED DESCRIPTION

This document describes document collaboration systems and methods that allow users to create, edit, manage, collaborate and communicate documents such as word processor documents, spreadsheets, databases, slides, diagrams, etc. In the systems and methods, each document is broken down into basic workable elements based on document type. In preferred exemplary embodiments, for example, the basic workable element for text documents is a paragraph; for spreadsheets, it is a cell; for databases it is a field; for presentations, it is the slide; for diagrams, it is a shape. The basic workable element can be version controlled and/or secured or not secured against privileged and/or unprivileged changes. The basic workable element can be redefined or scaled based on user preferences. For instance, for text documents, the basic workable element may be redefined from a paragraph to a sentence or a certain number of sentences.

Each change to a basic workable element of a document is tracked in a centralized database under control of a database management system, and users use a web browser and/or desktop as the client front end. Changes to the document as a whole are communicated back and forth to the database via a rich asynchronous javascript, XML and/or HTML. Changes from multiple sources or sessions can be compared with each other in a side-by-side display environment.

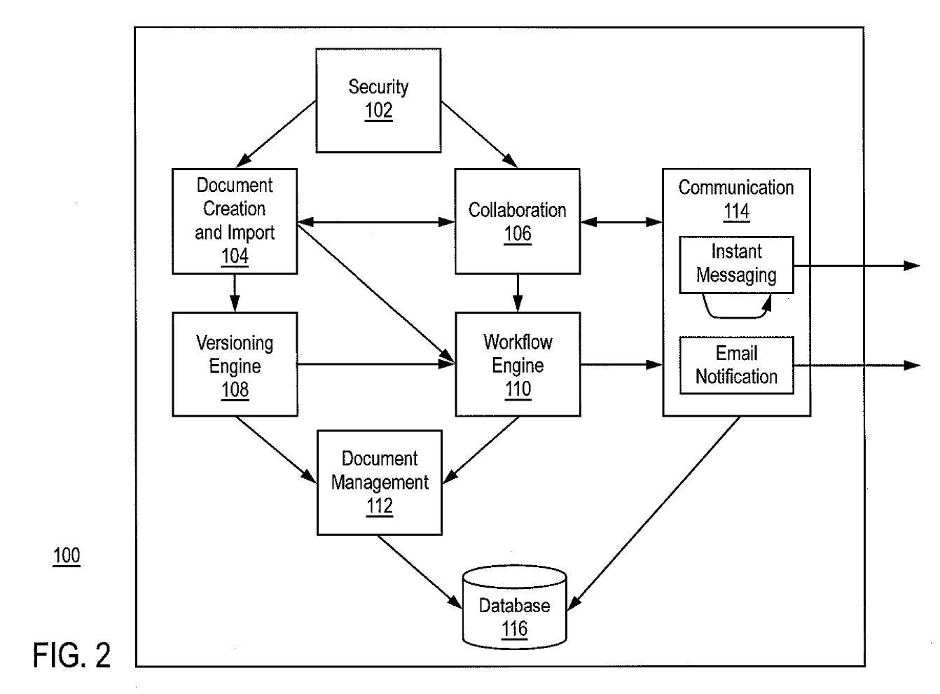

FIG. 2 is a block diagram of a document collaboration system 100. The document collaboration system 100 includes a security module 102, a document creation and import module 104, a collaboration module 106, and a versioning engine 108. The document collaboration system 100 further includes a workflow engine 110, a document management module 112, and a communications module 114. In exemplary embodiments, the document collaboration system 100 is hosted on a server or network of distributed servers, and is configured to interface with client computer systems over a network using standard file transfer protocols. In exemplary embodiments, the client computer systems include a processor and display running any of a number of standard browser programs. The functional modules of the document collaboration system 100 are described in further detail below.

Security Module 102

The security module 102 executes a password protected role-based security process. In some embodiments, a single password is required to access the document collaboration system 100, while a second password or other security measures can be required for accessing specific documents based on compliance with certain standards or regulations.

Document Creation and Import Module 104.

The document creation and import module 104 will be described in the context of a word processing document, however similar functionality applies to other document formats or types. The document creation and import module 104 provides for the creation of a new document or importing of an existing document, for editing and collaboration on that document. Documents are parsed into basic workable elements, e.g. individual paragraphs, and displayed in a slide view. Editing takes place one workable element at a time. Multiple users can be involved in collaborating on the workable element being edited. The workable element being edited or the entire document can be routed among approved users for review/editing/approval.

Changes from multiple users are displayed in a comparison view and easily selected and accessed or integrated back into a “current document” by a “Gatekeeper.” The gatekeeper is a user from the group of approved users who has been designated via the document collaboration system 100 to control the configuration and maintenance of the document, such that the most recent version exists yet the different prior versions of the workable elements and the entire document as a whole is archived for later searching, viewing, comparing, and editing.

The workable elements have unique identifiers that can be indexed for quick search capability. Changes to the workable element are tracked, as are which users made those changes, when the changes were made, and why. The document creation and import module 104 can track other aspects about changes as well. Changes take place in the form of insertions, deletions, replacements, and be tracked by a color scheme to differentiate individual users or contributors to the recent document.

Collaboration Module 106

The collaboration module 106 includes a number of applications, including contact management, calendaring, and project management. The collaboration module 106 executes the generation and transmission of invitations to one or more users via internet/intranet to participate in document creation/review/editing/approval etc. The collaboration module 106 also employs integrated communication tools such as instant messaging, email notification, mobile devices and RSS feeds to facilitate communication among users and the document collaboration system 100.

Versioning Engine 108

Changes to a workable element of a document are stored, and a new version number is assigned and archived in a database 116 with the document, by the versioning engine 108. The versioning engine 108 maintains a version history that can be stored in the database 116 and retrieved for review, comparison and editing.

Comparison can be accomplished between a number of different versions of a workable element in a side by side comparison. Preferably, the versioning engine 108 can display three different versions for comparison. Content from any version can be selected and integrated into the current or copied to a new document, triggering the document creation/importing/editing process described above.

Workflow Engine 110

The workflow engine 110 executes real-time creation of routing pathways (drag and drop technology) and live designation of specific actions coupled with timeline management. As workflow processes are invoked by the workflow engine 110, communication messages are delivered and received via email notifications, instant messaging, mobile devices, and/or RSS feeds.

Document Management Module 112

The document management module 112 executes security (dual password, password expiration, password encryption, password certification), electronic signature manifestation, watermark, account lock-out, intruder lock-out, field level change tracking, change rationale, and document restore functions.

Communications Module 114

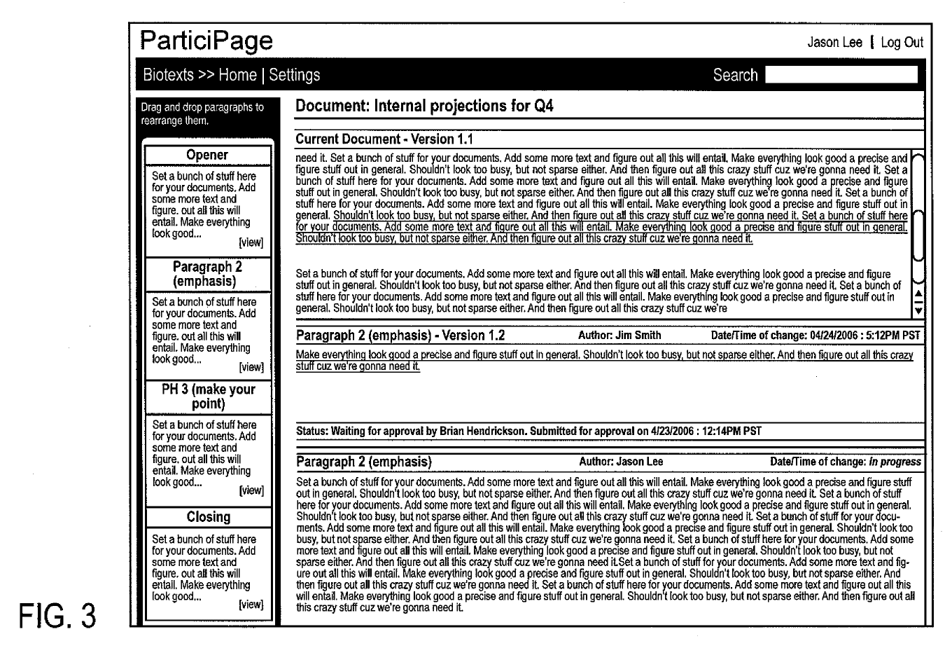

Communications are integrated within the document collaboration system 100 and are distributed across the collaboration module 114 and workflow module 112. Communications take the form of instant messaging, email notification, mobile device, and RSS Feeds. Communications may or may not be archived and stored within the system, depending on user preferences. FIG. 3 illustrates a collaboration session for a document using the document collaboration system.

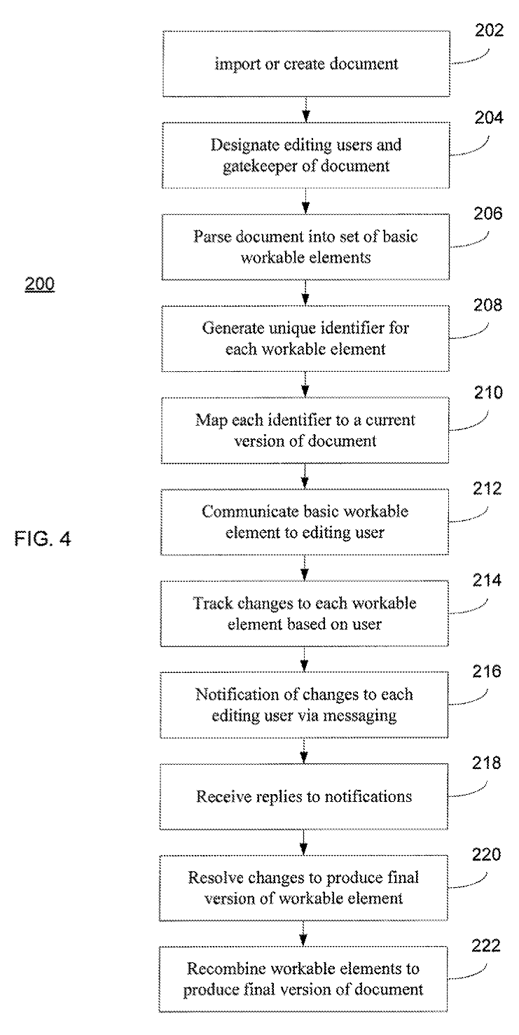

FIG. 4 is a flowchart of a workflow 200 for a document collaboration system in accordance with some embodiments. At 202, a document is created, preferably in a web-based document editor application running on a central server. Alternatively, a document is imported from another application, such as a local client-based document editor or creation application. The document can be a text document, a spreadsheet, a presentation, a graphics file, or other document such as source code, binary code, etc. At 204, one or more editing users are designated, the editing users being those users having access rights to view and/or edit the document. The editing users are assigned a unique user identifier (ID) and one or more passwords for access to the document. Additionally, at least one gatekeeper is designated from among the editing users. The gatekeeper has special administrative rights over the document during collaboration and for assembling a final version of the document. The gatekeeper can be changed as needed.

At 206, the document is parsed into a set of basic workable elements, i.e. broken into smallest atomic unit that still provides for efficient collaboration. In exemplary embodiments, for text documents the basic workable element can be a paragraph; for spreadsheets, it can be a cell; for databases, it can be a field; for presentations, it can be a slide or foil; for diagrams, it can be a shape. The basic workable element can be version controlled and/or secured or not secured against privileged and/or unprivileged changes. The basic workable element can be redefined or scaled based on user preferences. At 208, a unique ID is generated for each workable element. The basic workable element ID is used for indexing, versioning, storing and accessing the associated basic workable element. At 210, each basic workable element ID is mapped to a current version of the document.

At 212 selected basic workable elements are communicated to selected editing users. The selection of either the basic workable elements or the editing users can be made automatically based on configuration information provided to the system during setup or document creation, or managed by the designated gatekeeper. At 214, changes that are made to a basic working element by any of the editing users are tracked separately, and at 216 the system employs any of a number of messaging systems to notify other editing users of the changes. At 218, the system can receive replies to the messages and notifications. The replies can include an acceptance of the changes, additions or deletions, or other edits, or a rejection of the changes.

At 220 the tracked changes, along with the other pertinent information communicated among the editing users via messaging, are integrated and resolved to produce a final version of the workable element. The final version can still be changed, however, and continued to be tracked as described above. The final version can also be communicated to editing users or others that have been given access rights to the final version of the workable element. At 222, the basic workable elements are recombined to produce a final version of the document. The final version of the document, as well as the final version of each basic workable element, may be displayed showing a history of changes, with links to comments and messages communicated among the editing users. Accordingly, a precise history of the development of a document and all collaboration thereto are stored and accessible through the document collaboration system.

Embodiments of the document collaboration system and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g. a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the document collaboration system can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the document collaboration system have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A computer-implemented method comprising:
parsing a document into a set of basic workable elements, each basic workable element being a subset of the document;
communicating selected basic workable elements to designated editing users;
receiving changes to at least one basic workable element from at least one editing user; and
resolving the changes to produce a final version of the at least one basic workable element.

2. A computer-implemented method in accordance with claim 1, further comprising notifying selected designated editing users of the changes via a messaging system.

3. A computer-implemented method in accordance with claim 2, wherein the messaging system includes electronic mail.

4. A computer-implemented method in accordance with claim 2, wherein the messaging system includes a short messaging service (SMS).

5. A computer-implemented method in accordance with claim 2, further comprising generating a unique identifier for each basic workable element.

6. A computer-implemented method in accordance with claim 5, further comprising mapping each unique identifier to the document.

7. A computer-implemented method in accordance with claim 6, further comprising recombining the changed basic workable elements to produce a final version of the document.

8. A document collaboration method comprising:
providing a document in a central storage;
parsing the document into a set of basic workable elements, each basic workable element being a subset of the document;
receiving changes to at least one basic workable element from at least one editing user; and
resolving the changes to produce a final version of the at least one basic workable element.

9. A document collaboration method in accordance with claim 8, further comprising communicating selected basic workable elements to designated editing users.

10. A document collaboration method in accordance with claim 9, wherein communicating selectable basic workable elements includes transmitting the selectable basic workable elements via an electronic mail system.

11. A document collaboration method in accordance with claim 9, wherein communicating selectable basic workable elements includes transmitting the selectable basic workable elements via a short messaging system.

12. A document collaboration method in accordance with claim 8, further comprising displaying at least one basic workable element in a side-by-side comparison based on changes to the basic workable element from two or more editing users.

13. A document collaboration method in accordance with claim 8, further comprising generating a unique identifier for each basic workable element.

14. A document collaboration method in accordance with claim 13, further comprising mapping each unique identifier to the document.

15. A document collaboration method in accordance with claim 14, further comprising recombining the changed basic workable elements to produce a final version of the document.

16. A document collaboration system comprising:
a database configured for storing a document;
a workflow engine that executes real-time creation of routing pathways and live designation of specific actions on the document;
a collaboration module that executes the generation and transmission of invitations to one or more users to provide the specific actions on the document via a network; and
a versioning engine that maintains a version history that can be stored in the database and retrieved for review, comparison and editing.

17. A document collaboration system in accordance with claim 16 further comprising a communications module to execute communications of the specific actions via any of a number of forms messaging.
